(19) United States
(12) Patent Application Publication
(10) Pub. No.: US 2006/0150583 A1
(43) Pub. Date: Jul. 13, 2006

(54) Adjustable horse bit

(76) Inventor: Qi Zhi Hong, Jiang Xi (CN)

Correspondence Address: BARLEY SNYDER, PO BOX 1559, LANCASTER, PA, 17608-1559, US

(21) Appl. No.: 11/330,627

(22) Filed: Jan. 12, 2006

Related U.S. Application Data
(60) Provisional application No. 60/643,742, filed on Jan. 12, 2005.

(51) Int. Cl. B68B 1/06

(52) U.S. Cl. 54/9

(57) ABSTRACT

An adjustable horse bit includes a mouthpiece and first and second cheeks. The mouthpiece has first and second bars. The first and second bars each have a substantially smooth outer surface and a threaded outer surface. The first and second cheeks each have a connector with a threaded passageway. Each of the threaded passageways is engaged with one of the threaded outer surfaces. A collar is fixed in each of the passageways. Each of the collars is arranged on the substantially smooth outer surfaces of the first and second bars and has a through-hole formed such that the substantially smooth outer surfaces can advance through the respective collars when the respective first or second cheek is rotated.

### CROSS-REFERENCE TO RELATED APPLICATIONS

This application claims the benefit of U.S. Provisional Application Ser. No. 60/643,742, filed Jan. 12, 2005.

### FIELD OF THE INVENTION

The invention relates to horse bits and, more particularly, to an adjustable horse bit and a method for making the same.

### BACKGROUND OF THE INVENTION

A horse bit is used to communicate with and control a horse by applying pressure to the horse's mouth. The bit generally rests in an open space between the horse's teeth where the horse's gums are exposed and has a set of rings for securing a set of reins. By pulling on the reins, a rider applies pressure to the bit and thereby communicates a command to the horse. The bit is formed so that the bit does not damage the horse's gums or other areas of the horse's mouth when the rider applies pressure thereto.

Because the width and shape of the horse's mouth will vary with the age and the breed of the horse, a particular horse may require several different size bits throughout its lifetime. Additionally, because of size variances, a single bit usually can not be used on more than one horse. It is therefore desirable to develop a bit that will not damage the horse's mouth and can be adjusted to appropriately fit the mouth of a particular horse so that the bit may be used throughout the life of the horse and/or on more than one horse.

### BRIEF SUMMARY OF THE INVENTION

The invention relates to an adjustable horse bit that includes a mouthpiece having at least one bar with a threaded outer surface and a substantially smooth outer surface. First and second cheeks are separated by the mouthpiece. At least one cheek has a connector with a threaded passageway engaged with the threaded outer surface. A collar is fixed in the threaded passageway and is arranged on the substantially smooth outer surface. The collar has a through- hole formed such that the substantially smooth outer surface can advance therethrough when the first or second cheek is rotated.

The invention further relates to an adjustable horse bit that includes a mouthpiece having first and second bars. The first and second bars each have a substantially smooth outer surface and a threaded outer surface. First and second cheeks each have a connector with a threaded passageway. Each of the threaded passageways is engaged with one of the threaded outer surfaces. A collar is fixed in each of the passageways. Each of the collars is arranged on the substantially smooth outer surfaces of the first and second bars and has a through-hole formed such that the substantially smooth outer surfaces can advance through the respective collars when the respective first or second cheek is rotated.

The invention still further relates to a method for making an adjustable horse bit. The method includes arranging a collar on a substantially smooth outer surface of a mouthpiece, threading the mouthpiece into a threaded passageway of a connector that is integrally formed with a cheek until the collar is received in the passageway, and fixing the collar in the passageway.

### BRIEF DESCRIPTION OF THE DRAWINGS

FIG. 1 is a plan view of an adjustable horse bit according to the invention;

FIG. 2 is an exploded view of the adjustable horse bit shown in FIG. 1;

FIG. 3 is a partial cross sectional view of the adjustable horse bit shown in FIG. 1 in a first position; and

FIG. 4 is a partial cross sectional view of the adjustable horse bit shown in FIG. 1 in a second position.

### DETAILED DESCRIPTION OF THE INVENTION

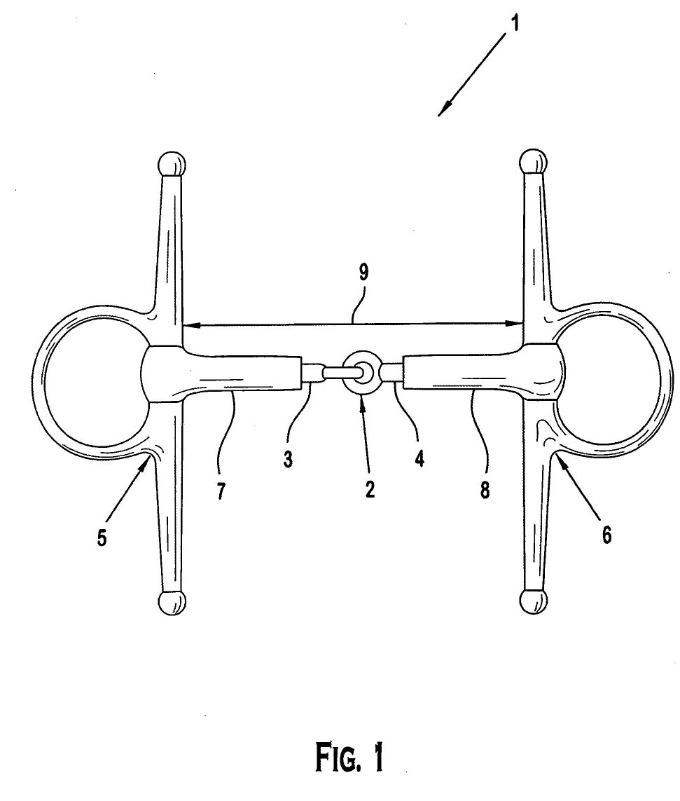

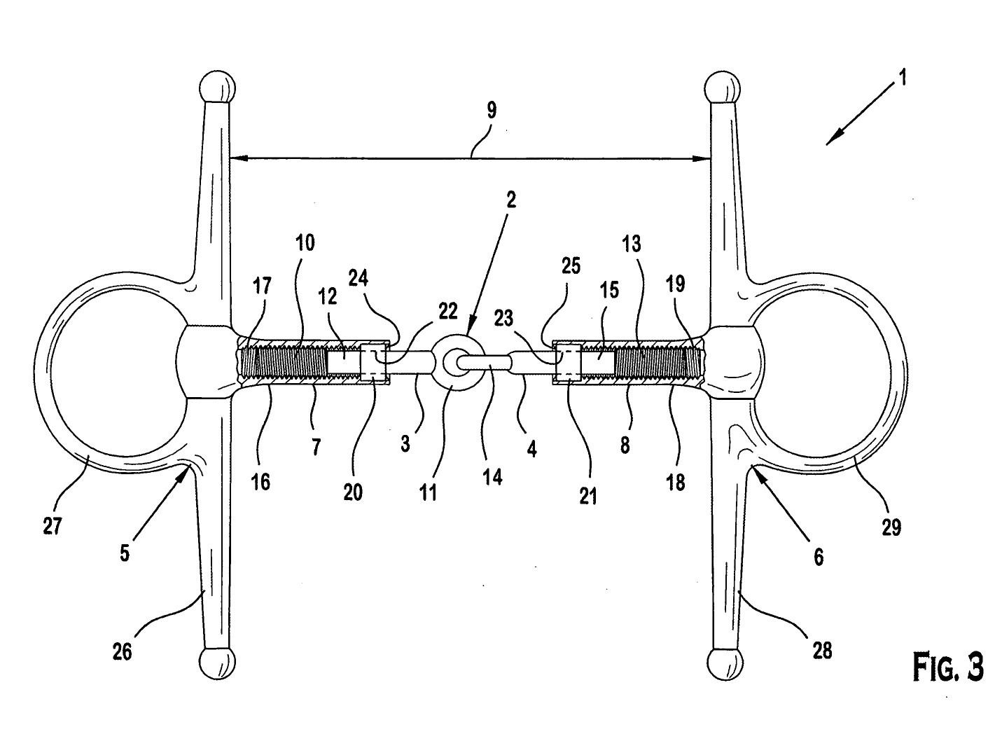

FIG. 1 shows an adjustable horse bit 1. The adjustable horse bit 1 includes a mouthpiece 2. The mouthpiece 2 consists of a first bar 3 and a second bar 4. The first bar 3 is attached to a first cheek 5 by a first connector 7. The second bar 4 is attached to a second check 6 by a second connector 8. The first cheek 5 and the second check 6 are separated by a distance 9. As best shown in FIG. 3, a first collar 20 is arranged in the first connector 7. A second collar 21 is arranged in the second connector 8. The distance 9 may be adjusted by twisting the first and second cheeks 5, 6 so that the first bar 3 is advanced through the first collar 20 and the second bar 4 is advanced through the second collar 21.

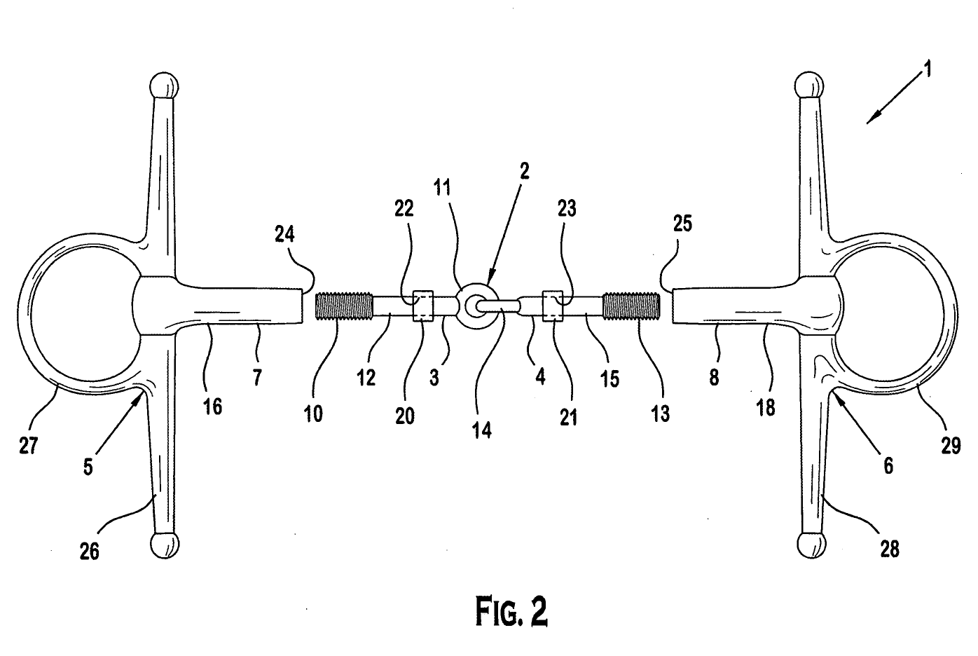

The individual elements of the adjustable horse bit 1 will now be described in greater detail. As shown in FIG. 2, the mouthpiece 2 includes the first bar 3 and the second bar 4. The first bar 3 has a first eyelet 11, a substantially smooth first outer surface 12, and a threaded first outer surface 10. The first collar 20 is arranged on the substantially smooth first outer surface 12. The first collar 20 has a first through-hole 22 having substantially the same diameter as the substantially smooth first outer surface 12 such that the substantially smooth first outer surface 12 is slip fit therein. The first through-hole 22 has a diameter smaller than a diameter of the threaded first outer surface 10.

The second bar 4 has a second eyelet 14, a substantially smooth second outer surface 15, and a threaded second outer surface 13. The second collar 21 is arranged on the substantially smooth second outer surface 15. The second collar 21 has a second through-hole 23 having substantially the same diameter as the substantially smooth second outer surface 15 such that the substantially smooth second outer surface 15 is slip fit therein. The second through-hole 23 has a diameter smaller than a diameter of the threaded second outer surface 13.

The first eyelet 11 is joined to the second eyelet 13 to attach the first bar 3 to the second bar 4. This joint is well known in the art as a snaffle joint. Although the mouthpiece 2 shown in the illustrated example is a snaffle joint, the first and second bars 3, 4, may be connected by any commonly known means. Alternatively, the mouthpiece 2 may be formed from a single bar.

As shown in FIGS. 2 and 3, the first connector 7 has a substantially smooth first external surface 16 and a first open end 24 leading into a first threaded passageway 17. The first cheek 5 is integrally formed with the first connector 7 and includes a first cheek plate 26 and a first ring 27. The second connector 8 has a substantially smooth second external surface 18 and a second open end 25 leading into a second threaded passageway 19. The second cheek 6 is integrally formed with the second connector 8 and includes a second cheek plate 28 and a second ring 29. Although the first and second cheeks 3, 4 shown in the illustrated example are full cheeks, other types of cheeks may be used, for example, eggbutt, loose ring, dee, half cheek, kimberwick, liver pool, training, etc.

To form the adjustable horse bit 1, the first cheek 5 is integrally formed with the first connector 7. The first collar 20 is positioned on the first bar 3 so that the first collar 20 is arranged on the substantially smooth first outer surface 12 proximate the first eyelet 11. The first outer surface 10 of the first bar 3 is then threaded. The threaded first outer surface 10 is threaded into the first threaded passageway 17 until the first collar 20 is arranged inside the first passageway 17 proximate the first open end 24. The first collar 20 is then attached to the first connector 7. The first collar 20 may be attached to the first connector 7, for example, by welding. The second cheek 6 is integrally formed with the second connector 8. The second collar 21 is positioned on the second bar 4 so that the second collar 21 is arranged on the substantially smooth second outer surface 15 proximate the second eyelet 14. The second outer surface 13 of the second bar 4 is then threaded. The threaded second outer surface 13 is threaded into the second passageway 19 until the second collar 21 is arranged inside the second threaded passageway 19 proximate the second open end 25. The second collar 21 is then attached to the second connector 8. The second collar 21 may be attached to the second connector 8, for example, by welding.

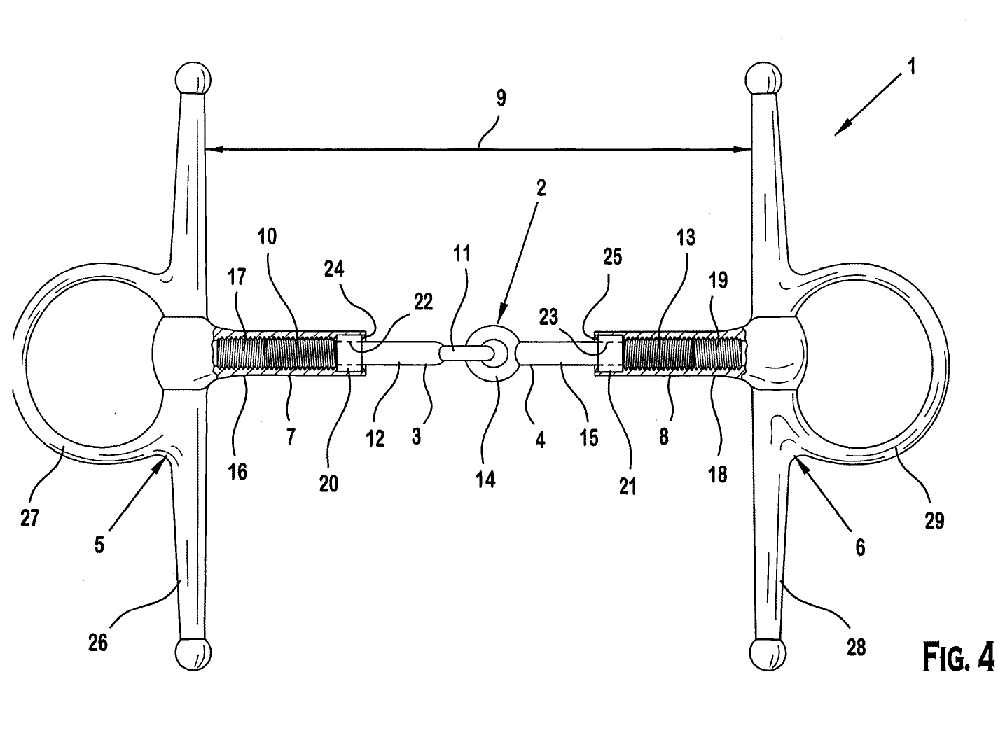

As shown in FIGS. 3 and 4, to adjust the distance 9 between the first and second checks 5, 6, the first and second cheeks 5, 6 are rotated so that the substantially smooth first outer surface 12 of the first bar 3 is advanced through the first collar 20 and the substantially smooth second outer surface 15 of the second bar 4 is advanced through the second collar 21. The substantially smooth first and second outer surfaces 13, 15 will advance through the respective first and second collars 20, 21 until the threaded first and second outer surfaces 10, 13 engage the respective first and second collars 20, 21. The threaded first and second outer surfaces 10, 13 thereby prevent the mouthpiece 2 from disengaging from the respective first and second connectors 7, 8. Additionally, because the threaded first and second outer surfaces 10, 13 of the respective first and second bars 3, 4 and the first and second collars 20, 21 are arranged within the respective first and second connectors 7, 8, the mouthpiece 2 and the first and second connectors 7, 8 form a continuous smooth surface for contacting the horse's mouth (not shown). The adjustable horse bit 1 thereby provides an appropriate fit within the horse's mouth (not shown) without risking damage to the horse's mouth (not shown).

The foregoing illustrates some of the possibilities for practicing the invention. Many other embodiments are possible within the scope and spirit of the invention. For example, in an alternate embodiment, only one of the first or second bars 3, 4 may be formed to be adjustable. It is, therefore, intended that the foregoing description be regarded as illustrative rather than limiting, and that the scope of the invention is given by the appended claims together with their full range of equivalents.

What is claimed is:

1. An adjustable horse bit, comprising:
a mouthpiece having at least one bar with a threaded outer surface and a substantially smooth outer surface;
first and second cheeks separated by the mouthpiece, at least one cheek having a connector with a threaded passageway engaged with the threaded outer surface; and
a collar fixed in the threaded passageway and arranged on the substantially smooth outer surface, the collar having a through-hole formed such that the substantially smooth outer surface can advance therethrough when the first or second cheek is rotated.

2. The adjustable horse bit of claim 1, wherein the mouthpiece includes a first eyelet and a second eyelet, the first eyelet being joined to the second eyelet to form the mouthpiece.

3. The adjustable horse bit of claim 1, wherein the collar is positioned proximate an open end of the connector.

4. The adjustable horse bit of claim 1, wherein the through-hole has a diameter smaller than a diameter of the threaded outer surface.

5. The adjustable horse bit of claim 1, wherein the collar is welded to the connector.

6. The adjustable horse bit of claim 1, wherein when the adjustable horse bit is assembled the mouthpiece and the first and second connector form a continuous smooth surface.

7. The adjustable horse bit of claim 1, wherein the first and second cheeks each include a cheek plate and a ring.

8. An adjustable horse bit, comprising:
a mouthpiece having first and second bars, the first and second bars each having a substantially smooth outer surface and a threaded outer surface;
first and second cheeks each having a connector with a threaded passageway, each of the threaded passageways being engaged with one of the threaded outer surfaces; and
a collar fixed in each of the passageways, each of the collars being arranged on the substantially smooth outer surfaces of the first and second bars and having a through-hole formed such that the substantially smooth outer surfaces can advance through the respective collars when the respective first or second cheek is rotated.

9. The adjustable horse bit of claim 8, wherein the first bar includes a first eyelet and the second bar includes a second eyelet, the first eyelet being joined to the second eyelet to attach the first bar to the second bar.

10. The adjustable horse bit of claim 8, wherein each of the collars is positioned proximate open ends of the respective connectors.

11. The adjustable horse bit of claim 8, wherein the through-holes have a diameter smaller than a diameter of the threaded outer surfaces.

12. The adjustable horse bit of claim 8, wherein the collars are welded to the respective connectors.

13. The adjustable horse bit of claim 8, wherein when the adjustable horse bit is assembled the mouthpiece and the first and second connector form a continuous smooth surface.

14. The adjustable horse bit of claim 8, wherein the first and second cheeks each include a cheek plate and a ring.

15. A method for making an adjustable horse bit, comprising the steps of:
arranging a collar on a substantially smooth outer surface of a mouthpiece;
threading the mouthpiece into a threaded passageway of a connector that is integrally formed with a cheek until the collar is received in the passageway; and
fixing the collar in the passageway.

16. The method of claim 15, wherein the collar is slip-fit on the smooth outer surface.

17. The method of claim 15, wherein the collar is fixed proximate an open end of the connector.

18. The method of claim 15, wherein the mouthpiece includes first and second bars fixed to each other by eyelets.

19. The method of claim 15, wherein when the mouthpiece and the connector form a continuous smooth surface.
